(19) United States
(12) Patent Application Publication
(10) Pub. No.: US 2010/0180303 A1
(43) Pub. Date: Jul. 15, 2010

(54) DIGITAL BROADCASTING RECEIVING APPARATUS

(76) Inventor: Noriyuki Kudo, Osaka (JP)

Correspondence Address: BIRCH STEWART KOLASCH & BIRCH, PO BOX 747, FALLS CHURCH, VA, 22040-0747, US

(21) Appl. No.: 12/602,729

(22) PCT Filed: Jun. 2, 2008
(86) PCT No.: PCT/JP2008/060124

§ 371 Date: Dec. 2, 2009

(30) Foreign Application Priority Data
Jun. 29, 2007 (JP) 2007-172758

(51) Int. Cl. H04N 5/445

(52) U.S. Cl. 725/44

(57) ABSTRACT

EPG information includes so many programs provided by digital broadcasting that creating an electronic program table based on the EPG information will cause the program display fields to be accordingly subdivided, thereby making it difficult to display all of the electronic program table information so as to be browsable. The present invention is characterized in that in a program table including a representative channel predetermined in a TS and channels other than that, display control is performed as follows: 1) The display width of the representative channel is arranged to be explicitly larger than (not less than 1.5 times of) those of channels other than the representative channel. In particular, the channels other than the representative channel are configured to have a width within which more than one character, which is of the size of the characters entered in program cells, cannot be displayed; and 2) The display areas for channels other than a representative channel is disposed at the side (left or right side) of the representative channel such that each broadcasting station, which includes a representative channel and channels other than the representative channel, has an approximately uniform display width.

### TECHNICAL FIELD

The present invention relates to a digital broadcasting receiving apparatus and particularly to a technique of displaying an electronic program table in the digital broadcasting receiving apparatus.

### BACKGROUND ART

In a digital broadcasting receiving apparatus for receiving digital television broadcasting, an electronic program table is created based on EPG (electronic program guide) information acquired from a broadcast signal and is displayed as an image on a screen. Then, a user can select a desired program from an electronic program table displayed as an image to view the program and reserve the recording thereof.

For example, a typical electronic program table is displayed as shown in FIGS. 12 to 19. FIG. 12 is a display of an electronic program table of transition origin. In FIG. 12, an electronic program table 171 is configured to have a matrix display structure of a time axis indication 173 and a broadcasting station axis (a channel axis) 175 along which, for example, broadcasting stations when they are provided by the same program provider are placed side by side, and program information (a program name in this case) of a corresponding time and broadcasting station is displayed in a program area (for example, 177-1 to 5) which is a crossing point of the aforementioned two axes. From the screen of FIG. 12, in a program area of a service ID 011 (XA-2) in a broadcasting station A (XA-1) (in the figure, it is shown by adding shadow that focus is placed on a program area XA-3), for example, program information (not shown) of a drama between 7 and 8 p.m. is displayed as shown in FIG. 13.

It is noted that in the figure, indications such as XA-n etc. refer to areas and indications such as 177-m etc. refer to program names etc.

In the margin of the electronic program table, a detailed display area is provided, in which as well, information on the focused program may be displayed in large characters. Configuration is made such that all the programs are displayed with the service ID and the time zone as minimum display units, in such a way that in the area of a broadcasting station B on which focus is not placed, for example, a program “Spring Travel” which is integrated as shown by a symbol 177-0 is displayed in the areas of service IDs 021, 022 and 023, or different programs, for example, “Summer Travel” 177-1, “English Conversation” 177-3, and “French Language” 177-4 are displayed in each service ID; further, in the next time zone, for example, “Autumn Travel” 177-2, “English Conversation” 177-3, and “Spanish Language” 177-5 are displayed; and further in the next time zone, for example, a program “Winter Travel” which is integrated as shown by a symbol 177-6 is displayed in the areas of service IDs 021, 022, and 023.

In this occasion, when focus is moved by right cursor, as shown in FIG. 14, focus is placed on the broadcasting station B, within which an area XA-6 of “Autumn Travel” 177-2 between 7 and 8 p.m. of the first service ID 021 is focused. Further, when focus is moved by right cursor, as shown in FIG. 15, focus remains to be placed on the broadcasting station B, within which a program area XA-8 of “English Conversation” between 7 and 8 p.m. of the second service ID 022 is focused. Further, when focus is moved by right cursor, as shown in FIG. 16, focus remains to be placed on the broadcasting station B, within which a program area XA-10 of “Spanish Language” between 7 and 8 p.m. of the third service ID 023 is focused. Further, when focus is moved by up cursor, as shown in FIG. 17, focus remains to be placed on the broadcasting station B, within which a program area XA-11 of “French Language” above “Spanish Language” between 7 and 8 p.m. of the third service ID 023 is focused. Further, when focus is moved by up cursor, as shown in FIG. 18, focus remains to be placed on the broadcasting station B, within which a program area XA-10 of “Spring Travel” above “Summer Travel” between 6 and 7 p.m. of the first service ID 021 is focused. Further, when focus is moved by down cursor, as shown in FIG. 19, focus remains to be placed on the broadcasting station B, within which a program area XA-11 of “Summer Travel” below “Spring Travel” between 6 and 7 p.m. of the first service ID 021 is focused. In this way, in general, configuration is made such that when the cursor is moved on, focus is placed on the program which is present in that direction.

Patent Document 1: JP Patent Publication (Kokai) No. 2002-10162A.

### DISCLOSURE OF THE INVENTION

### Problems to be Solved by the Invention

By the way, EPG information includes so many programs provided by digital broadcasting that creating an electronic program table based on the EPG information will cause the program display fields to be accordingly subdivided, thereby causing the problem that it is difficult to display all of the electronic program table information so as to be browsable.

It is an object of the present invention to improve the operability to reserve and select any one channel such as a representative channel and to increase the number of stations to be displayed on one screen of an electronic program table without sacrificing browsability. Further, it is also an object to maintain the operability of cursor and the compatibility of display between when all the channels are displayed and when they are summarized and displayed.

### Means for Solving the Problems

One broadcasting station is sectioned by the same supplier, the same TS, and a combination thereof etc. An example thereof includes television channels of one TS and of the same broadcast ID, etc. For example, NHK General and NHK Education etc. are respectively considered to be one broadcasting station.

The present invention is characterized in that, in a program table including representative channels predetermined in each TS and channels other than those, the following display control is performed.

1) The display width of a representative channel is arranged to be explicitly larger than (not less than 1.5 times of) those of channels other than the representative channel. In particular, channels other than the representative channel are configured to have a width within the limits of which even one character, which is of the size of the characters entered in program cells, cannot be displayed.

2) The display area for channels other than the representative channel is disposed at the side (left or right side) of the representative channel such that each broadcasting station, which includes a representative channel and channels other than the representative channel, has an approximately uniform display width.

3) In the above description, the width of a representative channel is set as follows.

In the above description, cells other than that of the representative channel have a width which allows to determine whether or not a cursor is put thereon, and when the cursor is not put on the representative channel, color arrangement of the cells is performed by the same algorithm as that of the representative channel, and when the cursor is put thereon as well, color arrangement of the cells is performed with the same color as when the cursor is put on the representative channel.

### ADVANTAGES OF THE INVENTION

According to the present invention, compared with a conventional program table, it is possible to display many broadcasting stations in a browsable form within a limited display area on a display screen. Further, it is possible to dispose one service in each broadcasting station with a large area of program cell so as to have a channel width in which program information such as a title can be displayed.

Since only a selected channel is disposed in a large size so that the positional relationship between areas in the cursor movement within one broadcasting station is fixed, it is possible to make the operation feeling while moving a cursor compatible with that of a conventional display scheme in which a representative channel and channels other than the representative channel have a uniform display width, thus providing consistency in user's operation feeling.

Fixing a selected channel will make it possible to move a cursor with the same feeling as before in the cursor movement while effecting a transition of the cursor from a spotted formation to a shared event.

### BRIEF DESCRIPTION OF THE DRAWINGS

FIG. 1 is a function block diagram to show a configuration example of a digital broadcasting receiving apparatus according to an embodiment of the present invention.

FIG. 2 is a function block diagram to show a configuration example of a recording/reproducing apparatus according to an embodiment of the present invention.

FIG. 3 is a flowchart to show an editing process of an electronic program table according to the present embodiment.

FIG. 4 shows a display example of an electronic program table which is edited based on an editing process of electronic program table according to the present embodiment and is displayed on a display.

FIG. 5 shows a display example of an electronic program table according to the present embodiment.

FIG. 6 shows a transition example of an electronic program table display according to the present embodiment.

FIG. 7 shows a transition example of an electronic program table display according to the present embodiment.

FIG. 8 shows a transition example of an electronic program table display according to the present embodiment.

FIG. 9 shows a transition example of an electronic program table display according to the present embodiment.

FIG. 10 shows a transition example of an electronic program table display according to the present embodiment.

FIG. 11 shows a transition example of an electronic program table display according to the present embodiment.

FIG. 12 shows a transition example of an electronic program table display according to a mode in which program frames are uniformly allocated.

FIG. 13 shows a transition example of an electronic program table display according to a mode in which program frames are uniformly allocated.

FIG. 14 shows a transition example of an electronic program table display according to a mode in which program frames are uniformly allocated.

FIG. 15 shows a transition example of an electronic program table display according to a mode in which program frames are uniformly allocated.

FIG. 16 shows a transition example of an electronic program table display according to a mode in which program frames are uniformly allocated.

FIG. 17 shows a transition example of an electronic program table display according to a mode in which program frames are uniformly allocated.

FIG. 18 shows a transition example of an electronic program table display according to a mode in which program frames are uniformly allocated.

FIG. 19 shows a transition example of an electronic program table display according to a mode in which program frames are uniformly allocated.

### DESCRIPTION OF SYMBOLS

A DIGITAL BROADCASTING RECEIVING APPARATUS
1 ANTENNA
3 DIGITAL BROADCASTING RECEIVING UNIT
5 HDMI INTERFACE UNIT
7 HDMI SIGNAL PROCESSING UNIT
11 DECODER
15 REMOTE CONTROLLER PHOTO-RECEPTION UNIT
17 CONTROL UNIT (CPU)
18 STORAGE UNIT
23 DISPLAY
25 VOICE SIGNAL PROCESSING UNIT
27 IMAGE SIGNAL PROCESSING UNIT

### BEST MODE FOR CARRYING OUT THE INVENTION

In the present description, “TS” is the abbreviation of Transport Stream, which is specified in the MPEG system standard (ISO/IEC 13818-1). A TS ID is an identifier allocated to each TS and is unique in a network. The same TS means that TS IDs are the same. Moreover, a channel of which first digit to discriminate programs is “1” is referred to as a representative channel.

A representative channel is defined by, for example, a TS information descriptor included in NIT (network information table) in the terrestrial digital broadcasting. It refers to a primary service which may be determined by manufacturers in the case of BS and CS. The display technique of an electronic program table relating to the present invention is characterized in that frames are created and disposed such that the areas defined by display frames of channels other than a representative channel are smaller compared with a display area defined by a display frame of the representative channel (which basically refers to any one channel in one broadcasting station or a channel having the smallest or largest service ID in one broadcasting station).

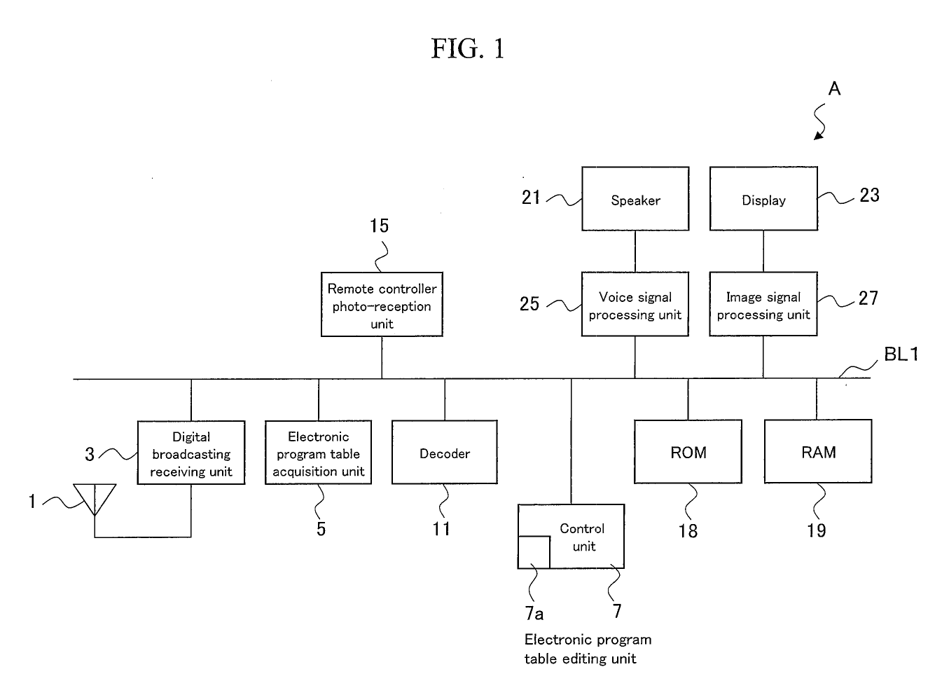

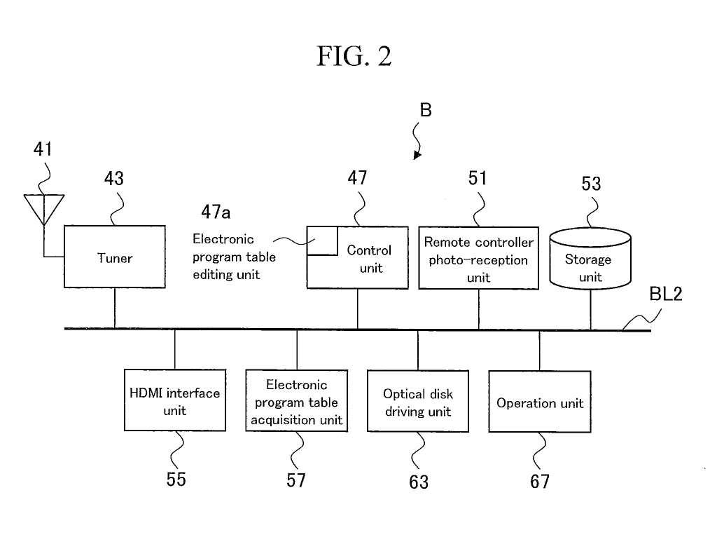

Hereafter, a digital broadcasting receiving apparatus according to an embodiment of the present invention will be described with reference to the drawings. FIGS. 1 and 2 show respectively an outline of a digital broadcasting receiving apparatus according to the present embodiment.

As shown in FIG. 1, the digital broadcasting receiving apparatus A includes an antenna 1, a digital broadcasting receiving unit 3 including a tuner of digital broadcasting, an electronic program table creating unit 5, a decoder 11, a remote controller photo-reception unit 15, a voice signal processing unit 25 for performing the processing of voice signals, a speaker 21 for outputting voices based on the voice signal after the processing, an image signal processing unit 27 for processing image signals, a display 23 for outputting images based on the image signals after the processing, a control unit (CPU) 7 for controlling each function block through a bus line BL1, and storage units (ROM and RAM) 18 and 19 for storing programs for performing the below described processing and other information. The control unit 7 includes, for example, an electronic program table editing unit 7a which is processed based on a program.

As shown in FIG. 2, the DVD (HDD) recorder (recording/reproducing apparatus) B includes an antenna 41, a digital tuner 43, a control unit 47, a remote controller photo-reception unit 51, a storage unit (HDD) 53, an HDMI interface unit 55, an electronic program table acquisition unit 57, an optical disk driving unit 63 such as a DVD, and an operation unit 67. The control unit 47 is provided with an electronic program table editing unit 47a which is operated by a program. Each of them can be operated by a corresponding remote control apparatus.

While the electronic program table is usable in any equipment, for example, if the equipment is compatible with the HDMI standard, the electronic program table can be displayed on the display 23 by connecting the both via an HDMI and using any remote control apparatus. The program information for creating an electronic program table may be extracted from the broadcast wave received by the above described digital broadcasting receiving unit, or may be separately acquired from the Internet etc.

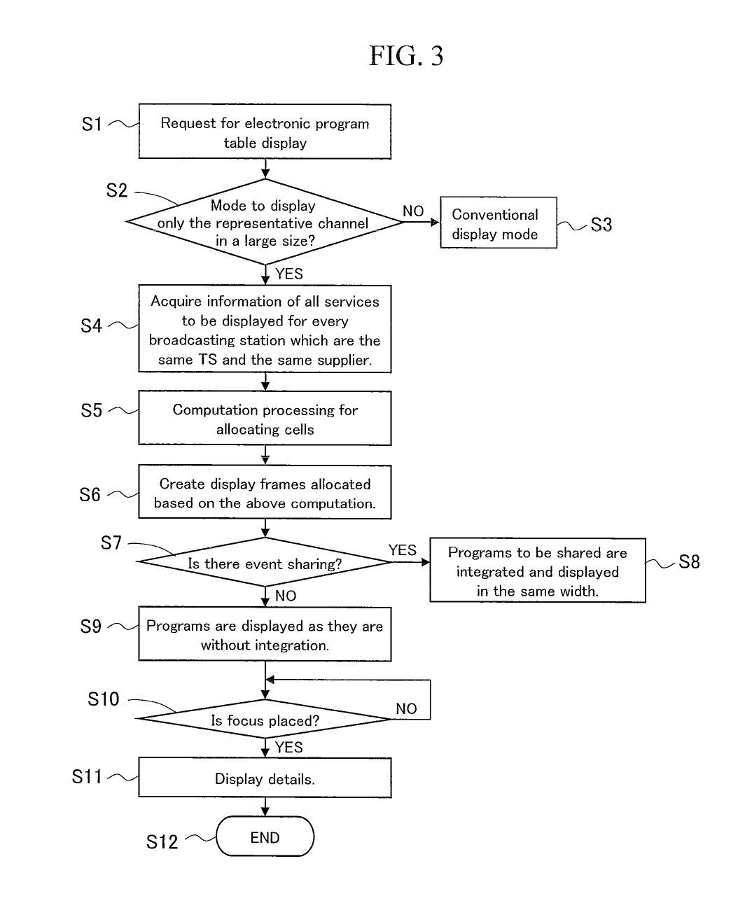

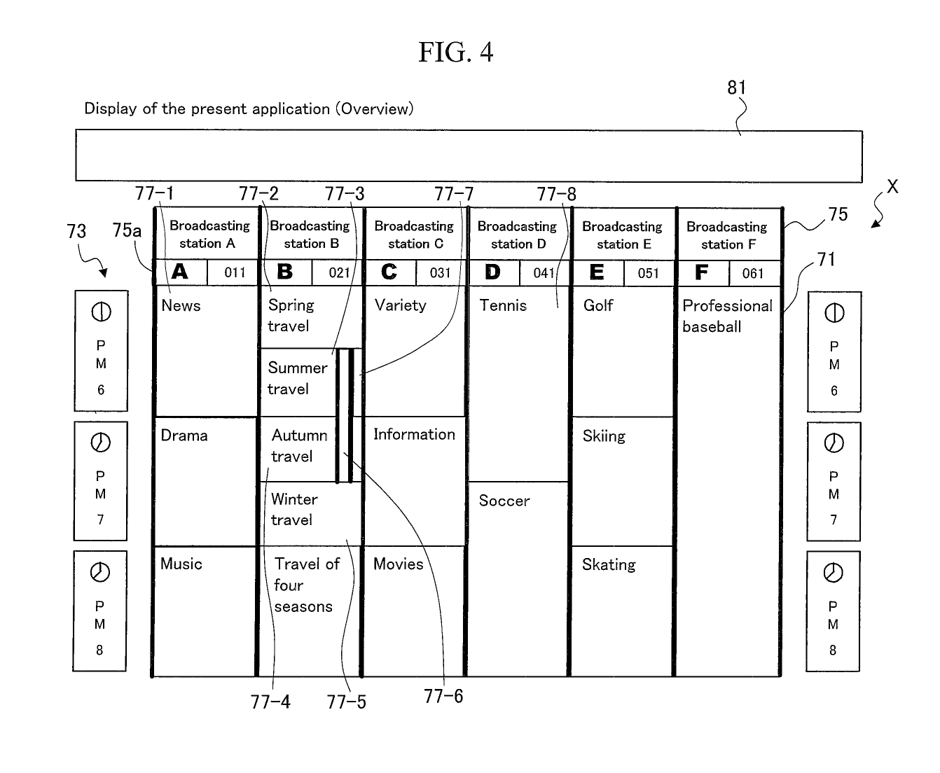

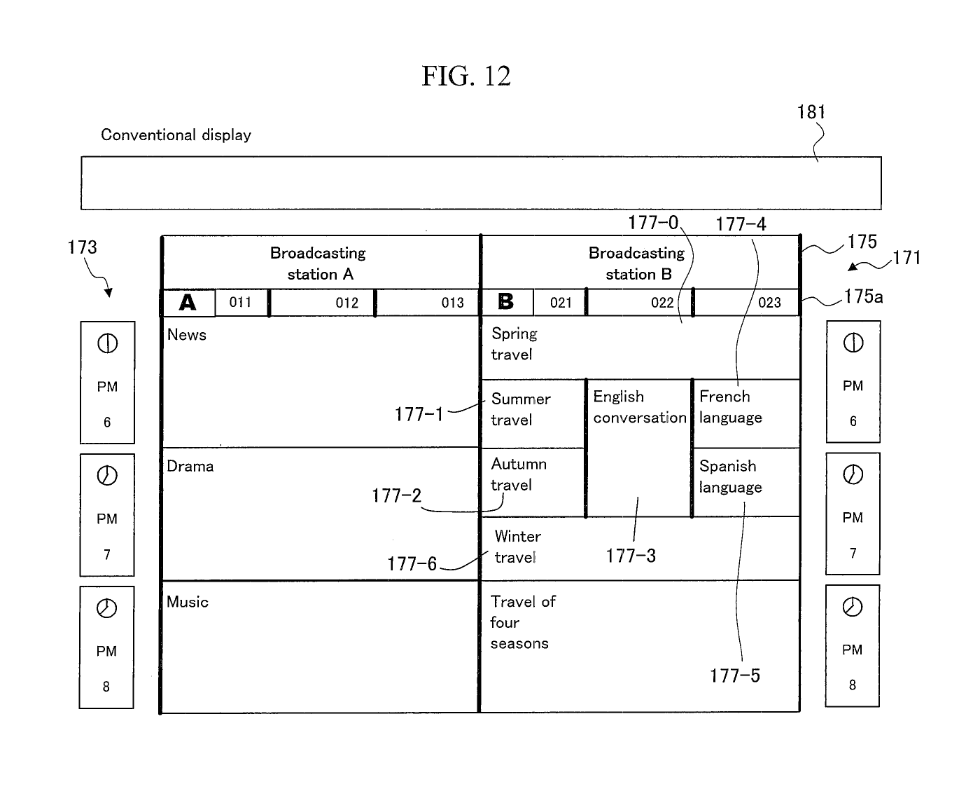

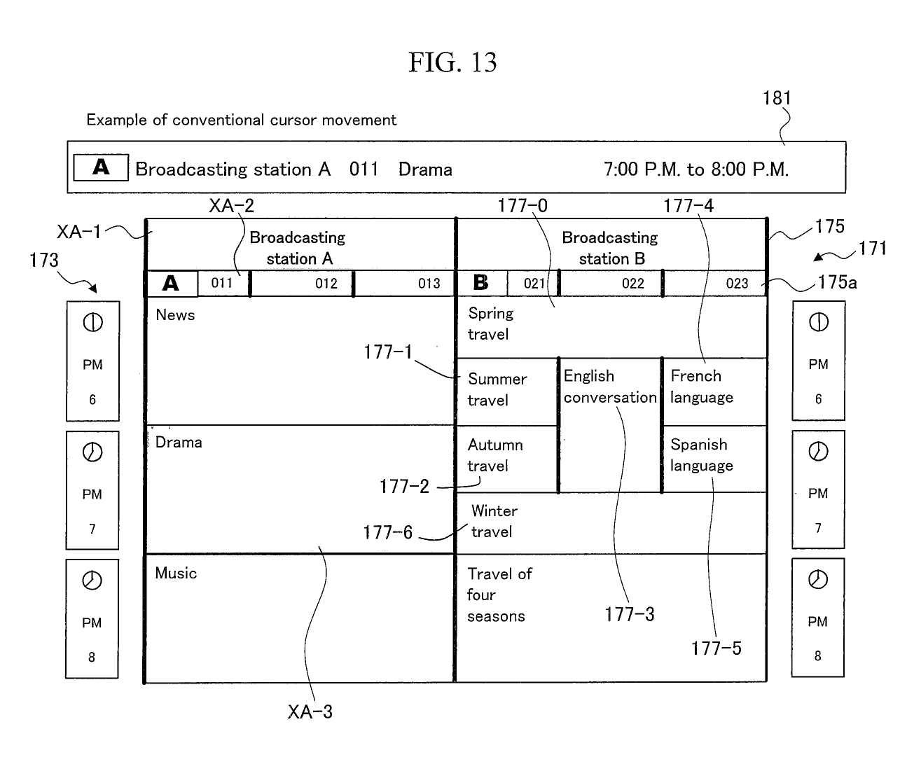

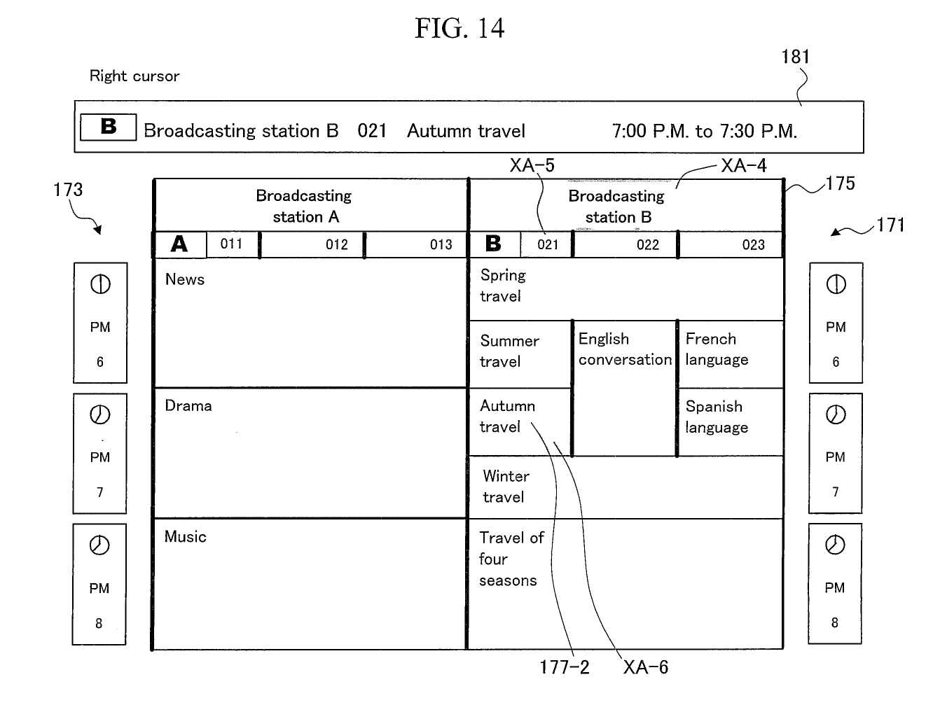

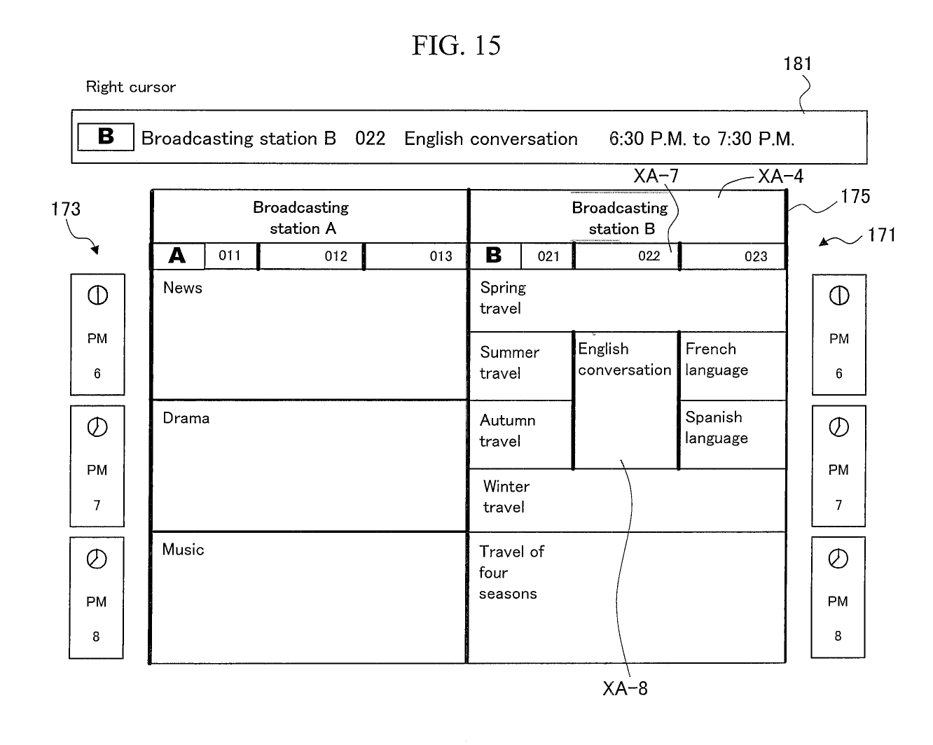

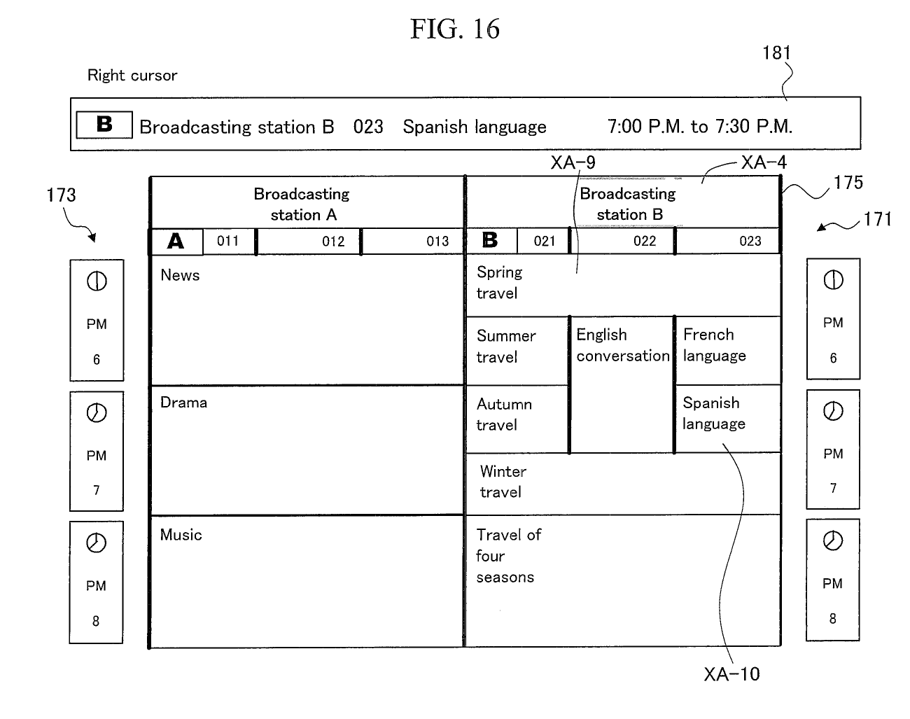

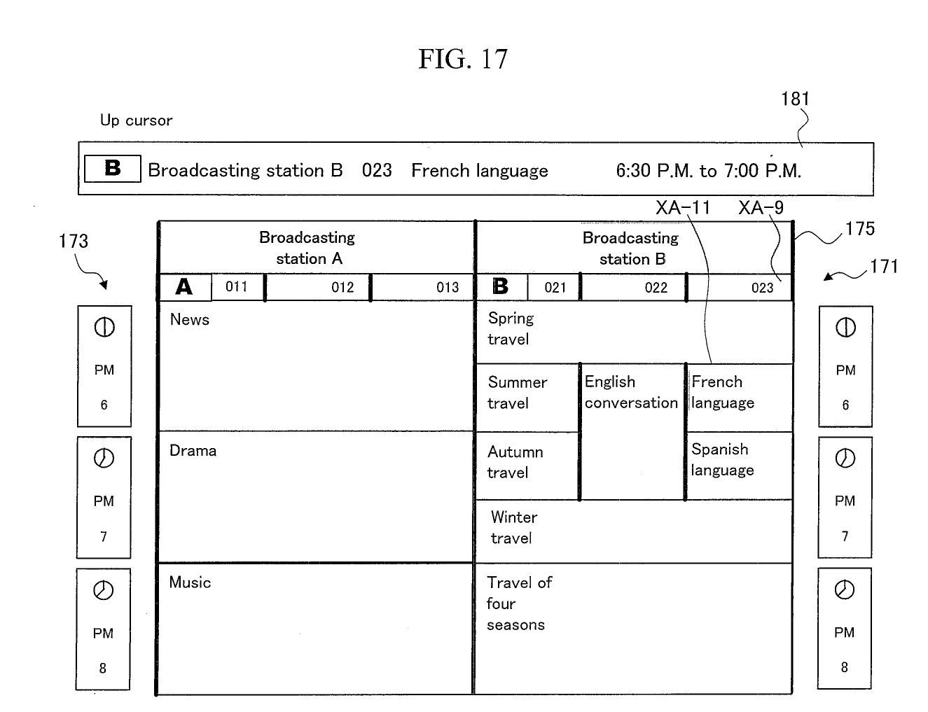

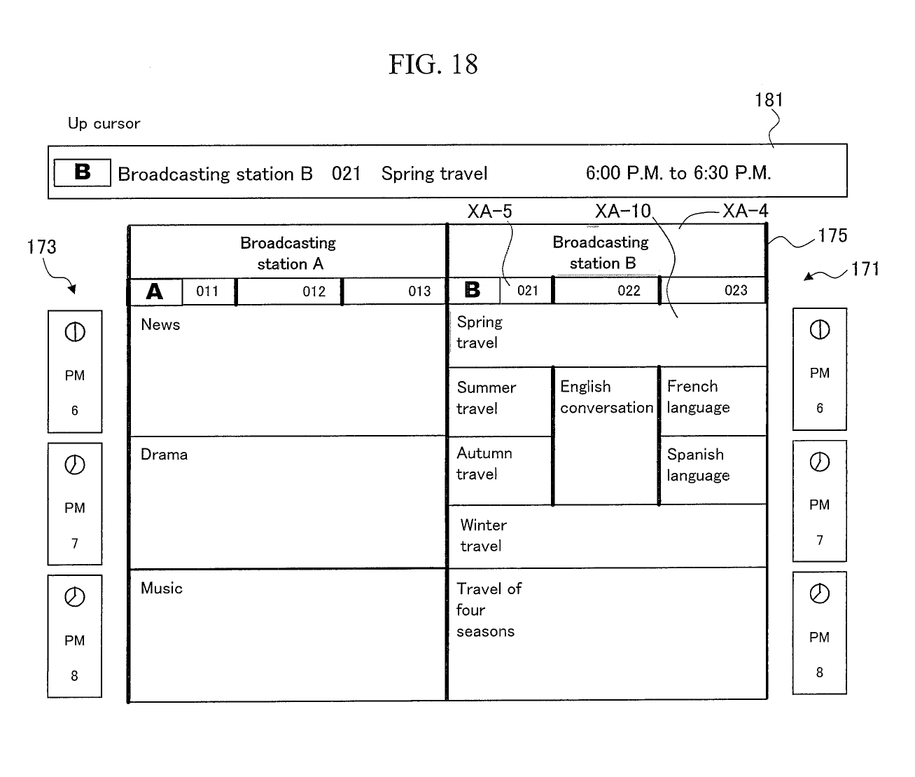

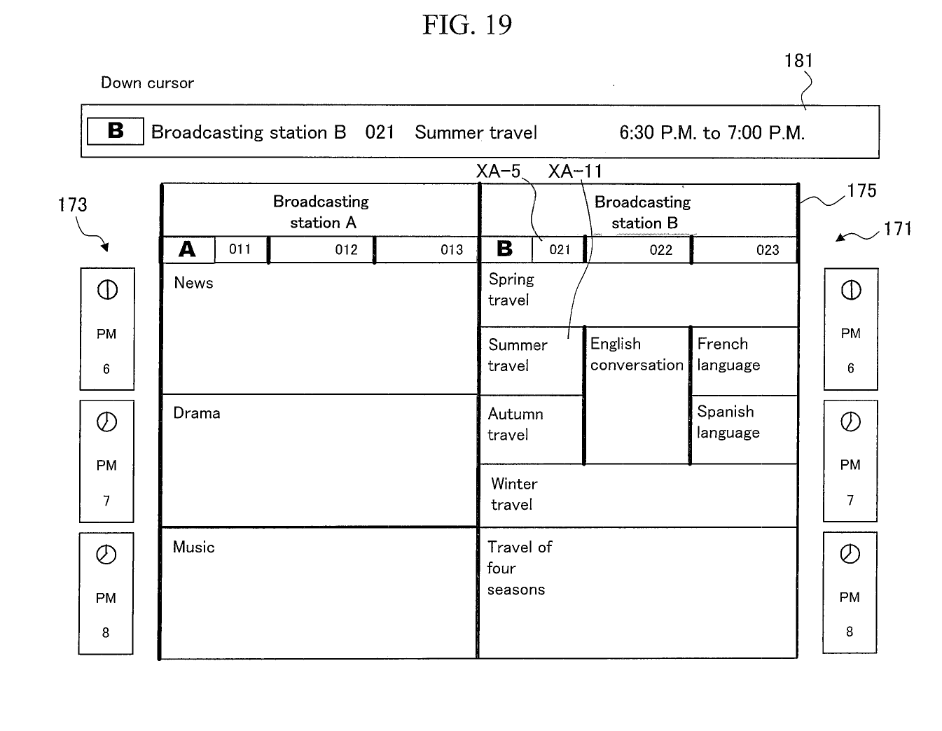

Next, the editing process of an electronic program table will be described based on the flowchart shown in FIG. 3. FIG. 4 shows a display example of an electronic program table which is edited based on the editing process of electronic program table of the present embodiment and is displayed on a display. First, in step S1, a request for EPG display is made by a user using an operation button of a remote control apparatus, etc. Next, in step S2, determination is made on whether the display request is made in a mode to display only the program frame of a representative channel in a large size when there is a representative channel, or in a mode to display program frames in the same size regardless of whether or not the channel is a representative channel. When it is not the mode to display only the program frame of a representative channel in a large size (No), the process proceeds to step S3. A display example based on the processing of the conventional display mode of step S3 has been described above with reference to FIGS. 12 to 19. When it is the mode to display only the program frame of a representative channel in a large size (Yes), the process proceeds to step S4 and the information of all the services to be displayed for each broadcasting station, which is sectioned by the same supplier, the same TS, and a combination thereof, is acquired from the electronic program table information, and in step S5, a computation processing for allocating cells is performed. Next, in step S6, display frames to be allocated are created based on the computation. From the processing in step S6, in step S7, determination is made on whether or not there is any event sharing, and when there is any event sharing (Yes), in step S8, programs to be shared are integrated and displayed without changing the width. When there is no event sharing (No), in step S9, programs are displayed as they are without integrating them. Television channels which are within one TS and have the same broadcast ID are basically configured to have the same width regardless of the number of services within the TS.

In the following, one example of the computation processing by a computing unit in step S5 will be described.

Basic computation equation:

(Display width of representative channel)=(display width of one broadcasting station)−(width of one channel other than representative channel)×((the number of channels of one broadcasting station)−1)

### First example

When the number of channels of one broadcasting station including a representative channel is 3, the display width of one broadcasting station is 10 (arbitrary unit), and the channel width of channels other than the representative channels is 1 (the same unit), the width of the representative channel is determined as follows:

(Width of representative channel)=10−(1×(3−1))=10−2=8

### Second Example

When the number of channels of one broadcasting station including a representative channel is 2, the display width of one broadcasting station is 10 (arbitrary unit), and the channel width of channels other than the representative channel is 1 (the same unit), the width of the representative channel can be determined as follows:

(Width of representative channel)=10−(1×(2−1))=10−1=9

As seen from those equations, the width in the channel axis direction for all the services displayed for each broadcasting station, which is in the same TS and of the same supplier, is fixed. The width of a representative channel is configured to be explicitly larger than those of other channels. The width is such that the former is a level of width in which displaying program names etc. can be satisfactorily achieved and the latter is a level of width in which displaying program names is difficult. This point will be described with reference to FIG. 4. As shown in FIG. 4, a display X of electronic program table according to the present embodiment includes, for example, a matrix-form arrangement 71 with a time axis 73 as a longitudinal axis and with a channel axis (axis sectioned for each broadcasting station) 75 as a lateral axis.

Putting FIG. 4 in contrast with FIG. 12 for the comparison with a conventional arrangement, in the display example shown in FIG. 12, in the two hours from the period between 6 and 7 p.m. to the period between 7 and 8 p.m. of the same broadcasting station B, when three different programs are broadcast at service channels of 021, 022 and 023 in the broadcasting station B, information on three different programs of 021, 022 and 023 are respectively displayed using uniform display frames for three services in the program display frame of one broadcasting station B as shown in 177-1 to 177-5. In this case, the width of one broadcasting station is proportional to the number of services.

In contrast to this, in the display example shown in FIG. 4, among three different programs between 6 and 7 p.m. and between 7 and 8 p.m. of the broadcasting station B, the channel 021, which is a representative channel, is allocated with a width of 8 (77-3 and 77-4) with respect to the entire width of 10 of the broadcasting station B, and channels 022 (77-6) and 023 (77-7) are respectively allocated with a width of 1 with respect to the entire width 10. The frames for sectioning each channel are fixed. It is preferable that the program information to be displayed within a frame (within a cell) is displayed only for a representative channel which has a sufficient area, and is not displayed for other areas.

Moreover, regarding narrow areas, in order to making their presence conspicuous, it is possible to improve the ease of visual recognition while being identified, by coloring only narrow areas with a primary color etc., using color-coding, adding a hatch pattern thereon, adding a unique mark thereon and so on. In the case of a representative channel, and when the cursor is not put on a narrow area, the color arrangement of the cells for a narrow area is performed by the same algorithm as that for a representative channel, and even when the cursor is put thereon as well, the color arrangement of the cells for a narrow area may be performed by the same color as that when the cursor is put on a representative channel.

In this way, fixing the allocation width in the channel axis direction for each broadcasting station will enable to predetermine the allocation width in the channel axis direction for each broadcasting station so that the frames for sectioning channels will not be displaced every time the cursor is moved in horizontal direction and therefore are easy to be seen, and next performing the above described computation based on the number of channels will enable to predetermine the allocation of the program display frames for programs in the same broadcasting station. Since when there is any event sharing, programs may be integrated to be displayed based on subsequent judgment, rapid displaying can be achieved. Moreover, displaying an electronic program table by predetermining a program table frame will enable a viewer to quickly recognize the possibility that a plurality of different programs are present in the same time zone regarding respective broadcasting station. It is noted that predetermining the arrangement of the program display frame in the same broadcasting station be performed in the ascending order from smaller number in the channel axis direction will be advantageous in that since the display is made in a fixed arrangement, it is easy for a user to recognize it. Moreover, compared with the configuration shown in FIG. 12, the width in the channel axis direction can be decreased, and information relating to more broadcasting stations can be displayed on a display, the browsability of the electronic program table will be advantageously improved.

Returning to FIG. 3, in step S10, determination is made on whether or not focus is placed on any of the program display fields. When it is determined that focus is placed (Yes), the process proceeds to step S11, and the details of the program on which focus is placed will be displayed on a large scale in a detailed display field 81 provided in the margin of the program display field in a large size. Finally, the editing/display processing of electronic program table is finished (step S12).

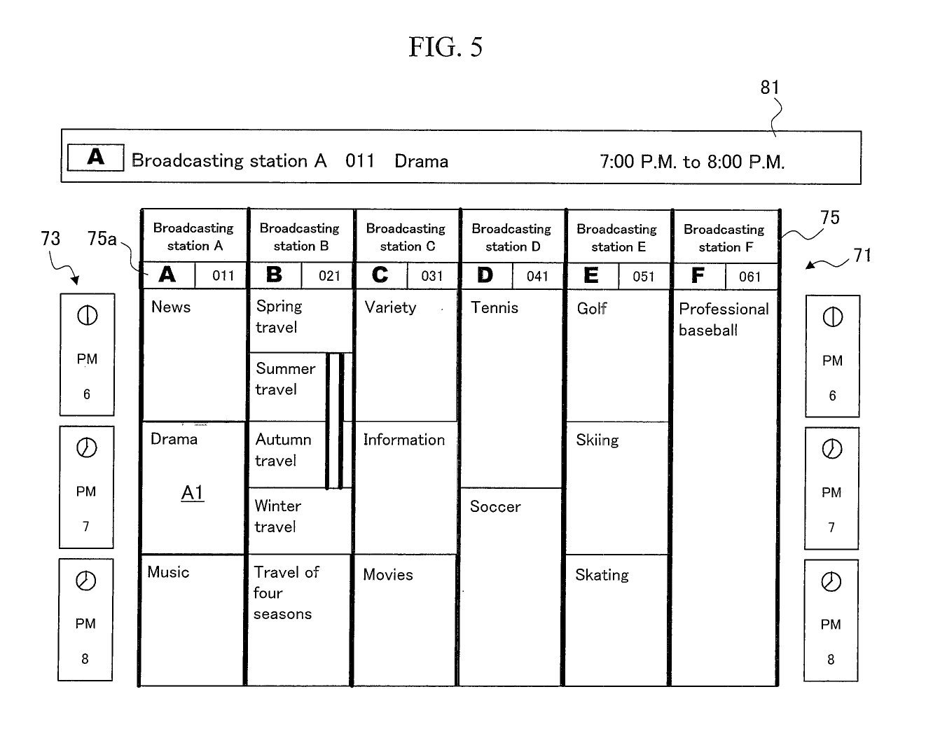

Hereinafter, description will be made on a display example when an area on which focus is placed is moved. As shown in FIG. 5, when focus is placed on a program display area A1 corresponding to between 7 and 8 p.m. of the broadcasting station A in the electronic program table 71 shown in FIG. 4, a display of “broadcasting station A”, the channel “011”, “Drama” and “7:00 p.m. to 8:00 p.m.” is performed in the detailed display field 81, and it becomes possible to proceed to operation of viewing, or starting or reserving image recording by the user.

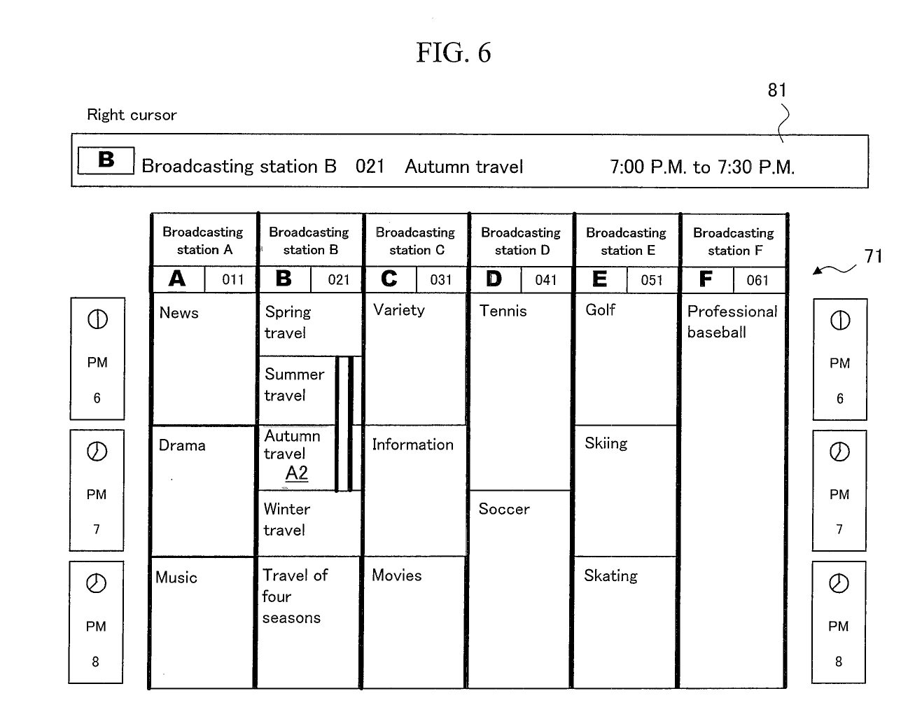

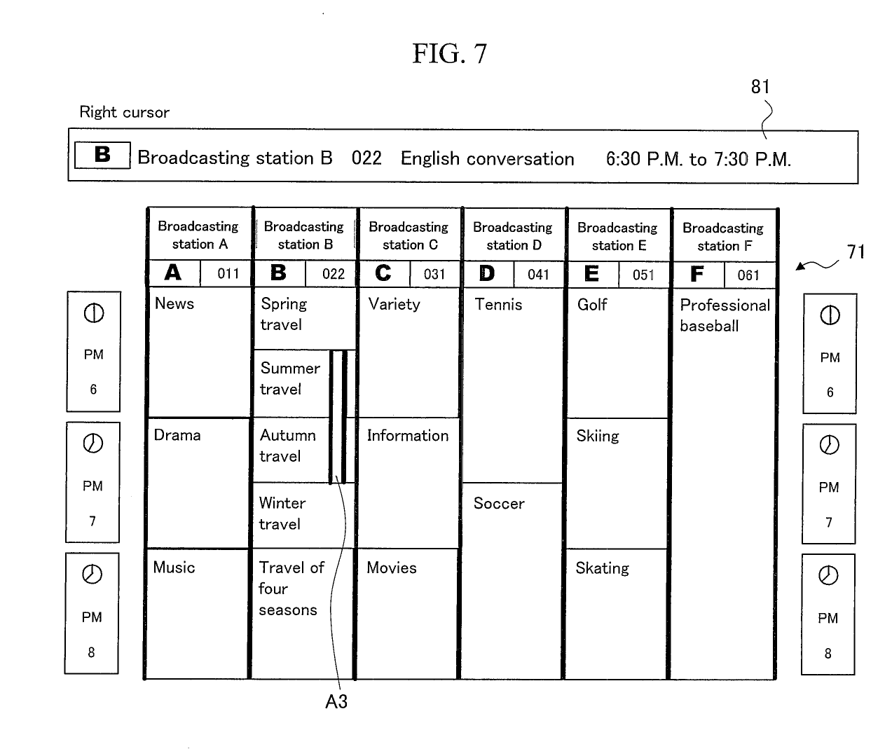

Next, upon performing the operation of moving focus by right cursor, configuration is made such that focus is placed on the 021 channel, which is between 7 and 8 p.m., that is, in the same time zone as in FIG. 5, and is the lowest channel number within the programs of the broadcasting station B on the right side of the broadcasting station A (and is also a representative channel in this case). When the time zone is divided, configuration is made such that focus is placed on “Autumn travel” in the area A2 which is a program area of which starting time is close to 7:00 of “Drama”. In this case as well, there are advantages in that since the frame itself of the broadcasting station B is not changed, visual recognition thereof is easy for the user and eye fatigue will be reduced, and moreover since the movement of the focused area in the horizontal cursor movement is in the same direction as that of cursor operation, there is no alienation between the user operation and the direction of cursor movement, and cognitive burden on the user is low. Of course, in the detailed display area 81, detailed information on “Autumn travel” is displayed. Next, when operation by right cursor is performed from the display of FIG. 6, focus is placed on the area A3 on the right side of the area A2 as shown in FIG. 7. By viewing the detailed area 81, it is seen that this program is “English conversation” of the 022 channel of the broadcasting station B, which is to be broadcast from 6:30 p.m. to 7:30 p.m. In this case, even if the same information is not displayed in the area A3 within the program display area, it is displayed in the detailed display area 81 and therefore is readily understandable for users. Since there are few switching of display, there is an advantage that it is rather easy to see.

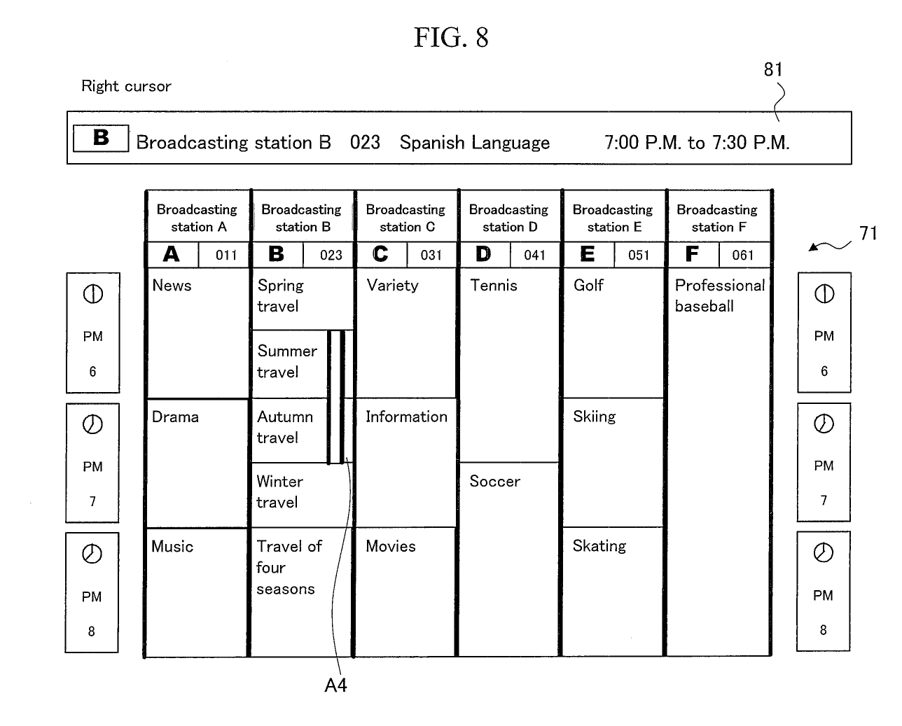

When right cursor is further used from the display of FIG. 7, a program from 7 p.m. is displayed in an area A4 as shown in FIG. 8. In this occasion, the reason why focus is not placed on the program from 6:30, but on the program from 7:00 is that focus has been placed on the program from 7:00 two steps earlier in FIG. 6. In this way, when an area spanning times is selected, determination is made on which area focus is to be placed with reference to the previous display state. That is, when right cursor is successively operated, the time zone on which focused is previously placed is stored so that the focused time zone during a series of operations is kept the same. The same processing may be performed for the case of left cursor.

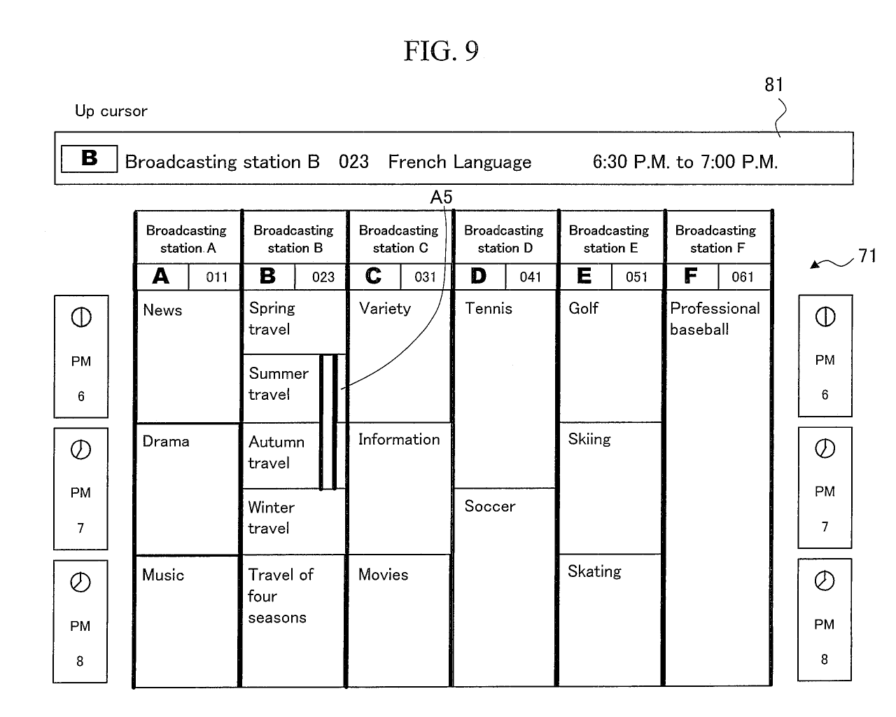

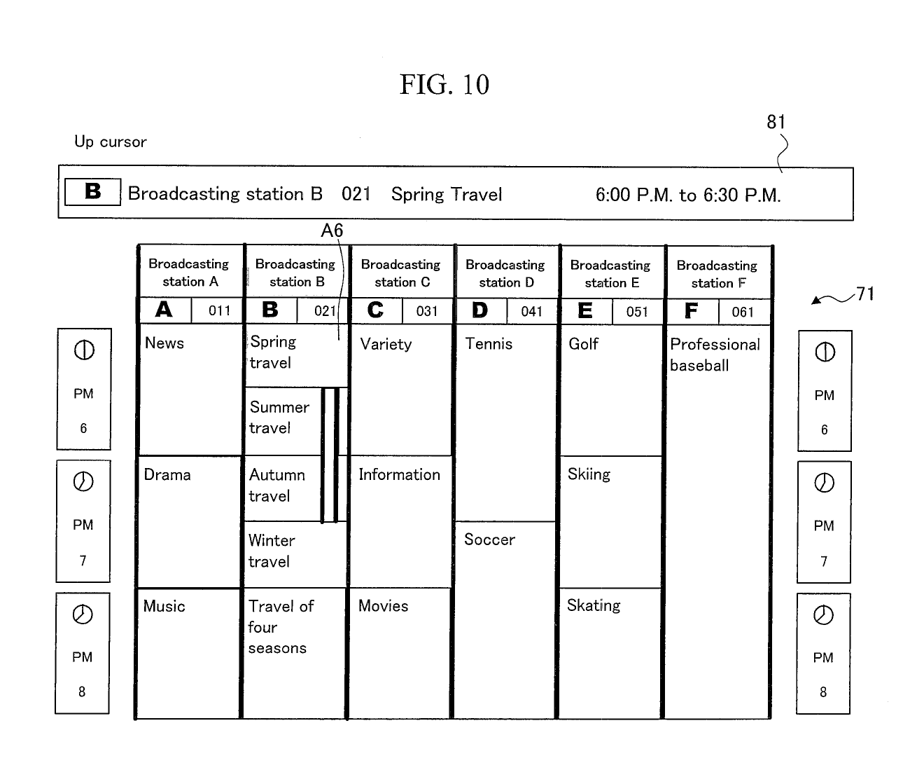

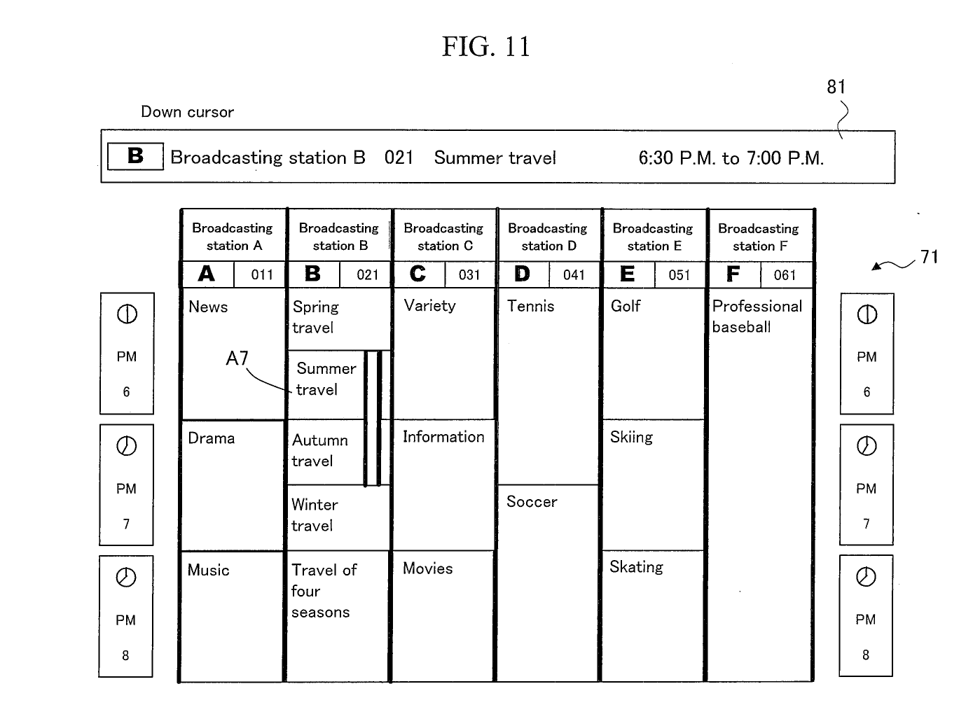

As shown in FIG. 9, when operation by up cursor is performed from FIG. 8, focus is placed on an area A5 of the immediately preceding program in the same program 023. Further, when operation by up cursor is performed, as shown in FIG. 10, focus is placed on “Spring travel” which is a program 021 in the immediately preceding time zone of the same broadcasting station B over the entire width of the channel axis of the broadcasting station B as shown in an area A6. Next, when operation of down cursor is performed, as shown in FIG. 11, focus is placed on the area A7 of the program immediately after the program 021. In this case, it is configured such that focus is placed on a program corresponding to the program of the immediately preceding channel.

As described so far, in the present embodiment, configuration is made such that the display area of a broadcasting station, which includes a representative channel and channels other than the representative channel, has the same width, and a channel with event sharing and a channel without event sharing, which is of a type of one service in one broadcasting station, have the same width.

It may also be configured such that a display mode shown in the display example described in the present embodiment and a conventional separate display mode (such as a scheme in which a representative channel and channels other than the representative channel are displayed in the same width, and a scheme in which only the representative channel is displayed) are switched by a menu and key manipulation, etc. In this occasion, it may be configured such that any of the above described display modes are selected by a menu manipulation, etc. independently (individually) for only a specific broadcasting station designated by the user, or for all broadcasting stations as a whole.

Moreover, the display mode as described above may be configured independently for each network (such as a terrestrial digital, CS digital, and BS digital networks), and as a whole for each network. For example, configuration may be such that only the terrestrial digital broadcasting adopts the display mode according to the present embodiment. Moreover, it may be configured such that a network as a whole adopts the above described display mode, or each broadcasting station independently sets the above described display mode individually by using a menu.

Moreover, the above described configuration may be taken as a whole for each medium (a television service, radio service, and data service). For example, only the television service may take on the above described configuration.

It is noted that when the number of display stations in a region is small such as in the terrestrial digital broadcasting, channels other than the representative channel may be displayed as needed within a browsable range. In that occasion, it is preferable that broadcasting stations which conduct multi-channel broadcasting such as a formation without event sharing are preferentially displayed in a browsable form. When a spotted formation is performed, it is preferable that the service number on which the cursor is put on is displayed or displayed in a highlight in the area where a broadcasting station logo is to be displayed, so that the selected channel in the broadcasting station is emphasized to be easily seen. It is noted that when the display of a one-touch button, or a one-touch key for the emphasized service is not allocated, the display of an icon button indicating a one-touch key may be deactivated or grayed down so as not to be emphasized.

It is noted that although, in the above described examples, description has been made on the case in which the representative channel is displayed in a larger size, the case in which an arbitrary channel is selected and the display frame for the arbitrary channel is made larger will not be excluded. Any channel designated by a user may be a representative channel. Therefore, such cases are included in the scope of the present invention. Moreover, the EPG display may be one in which the time axis and the channel axis are replaced with each other.

Moreover, since the digital broadcasting receiving apparatus includes a television receiving apparatus, a recording/reproducing apparatus, a personal computer, etc., the name and form of the product will not limit the invention.

### INDUSTRIAL APPLICABILITY

The present invention is applicable to digital broadcasting receiving apparatuses.

1-10. (canceled)

11. A digital broadcasting receiving apparatus, characterized by comprising:
a program information acquisition unit for acquiring program information; and
an electronic program table editing unit for editing an electronic program table based on the program information acquired by said program acquisition unit, wherein: even when one and the same program provider has a plurality of channels to provide programs, the width of every one broadcasting station in a channel axis direction is kept the same independent of the number of services within a TS; a first display width of a program information display area in said channel axis direction of a channel arbitrarily selected from said plurality of channels is larger than a second display width of program information display area of a channel other than said selected channel; and said first display width and said second display width are fixed independently of the focus movement in said program information display area.

12. The digital broadcasting receiving apparatus according to claim 11, characterized in that
said selected channel is a representative channel in the services within the TS.

13. The digital broadcasting receiving apparatus according to claim 11 or 12, characterized by comprising:
a computing unit for performing the computation to predetermine said first display width and said second display width.

14. The digital broadcasting receiving apparatus according to claim 13, characterized in that
said computing unit computes the channel width based on the following computing equation:
(display width of representative channel)=(display width of one broadcasting station)−(width of one channel other than representative channel)×(the number of channels of one broadcasting station)−1).

15. The digital broadcasting receiving apparatus according to claim 11, characterized in that
said display width in said channel axis direction of said non-selected channel is only a width within the limits of which even one character cannot be displayed.

16. The digital broadcasting receiving apparatus according to claim 11, characterized in that
the area of said second display width is displayed in a visually recognizable form.

17. The digital broadcasting receiving apparatus according to claim 11, characterized in that
when a cursor is not put on said selected channel, coloring of the area is performed by the same algorithm as that of said selected channel, and when the cursor is put thereon, coloring of the area is performed with the same color as that of the case in which the cursor is put on said representative channel.

18. The digital broadcasting receiving apparatus according to claim 11, characterized in that
when focus is placed on the area of said second display width, said editing unit creates a detailed display area for displaying detailed program information of said area in a separate column.

19. The digital broadcasting receiving apparatus according to claim 11, characterized in that
in order to keep a time zone the same in a series of operations on which focus is placed, a time zone on which focus is previously placed is stored and when an area spanning times is selected by the cursor, determination is made on which area focus is to be placed with reference to a previous display state.

20. The digital broadcasting receiving apparatus according to claim 11, characterized by comprising:
a mode to display only said selected channel in a large width, and
a mode to display all the channels in the same width.

21. The digital broadcasting receiving apparatus according to claim 11, characterized in that
even if event sharing is not performed in a channel, said electronic program table editing unit performs the same displaying as that for a channel in which all events are shared by the channel, as long as no event is presented on a display.
